(19) United States
(12) Patent Application Publication
(10) Pub. No.: US 2022/0274105 A1
(43) Pub. Date: Sep. 1, 2022

(54) DETECTION CHIP AND MODIFICATION METHOD THEREFOR

(71) Applicant: BOE Technology Group Co., Ltd., Beijing (CN)

(72) Inventors: Yudan YIN, Beijing (CN); Jing YU, Beijing (CN); Haonan LIU, Beijing (CN); Zhukai LIU, Beijing (CN)

(21) Appl. No.: 17/631,460

(22) PCT Filed: Mar. 3, 2021
(86) PCT No.: PCT/CN2021/078946

§ 371 Date: Jan. 29, 2022

(30) Foreign Application Priority Data
Mar. 19, 2020 (CN) 202010196126.6

(51) Int. Cl. B01L 3/00; C03C 17/30

(52) U.S. Cl. CPC B01L 3/502707; C03C 17/30; C03C 2218/111

(57) ABSTRACT

Disclosed are a detection chip and a modification method therefor. The modification method includes performing a surface activation treatment on a hydrophilic layer of the detection chip, such that a hydroxy-containing modification group is formed on a surface of the hydrophilic layer; then performing a surface amination treatment on the hydrophilic layer using a solution containing an amino compound, such that an amino-containing modification group is formed on the surface of the hydrophilic layer, and performing a surface carboxylation treatment on the hydrophilic layer using a solution containing an anhydride compound, such that a carboxyl-containing modification group is formed on the surface of the hydrophilic layer.

### CROSS REFERENCE TO RELATED APPLICATIONS

The disclosure is a national phase entry under 35 U.S.C § 371 of International Application No. PCT/CN2021/078946, filed Mar. 3, 2021, which claims priority to the Chinese Patent Application No. 202010196126.6, filed to the China National Intellectual Property Administration on Mar. 19, 2020 and entitled “DETECTION CHIP AND MODIFICATION METHOD THEREFOR”, the entire contents of which are incorporated herein by reference.

### FIELD

The disclosure relates to the technical field of biomedicine, in particular to a detection chip and a modification method therefor.

### BACKGROUND

The concept of microfluidic technology was originally derived from Micro Total Analysis Systems (μ-TAS) and proposed by scientists Manz and Widmer in 1990. Professor Manz successfully applied a Microelectromechanical System (MEMS) technology to the chemical and biological analysis and realized high-speed capillary electrophoresis on the microfluidic soon. His achievement was published on journals such as Science magazine, making this field get great attention in the science and become one of most cutting-edge fields of science and technology in the world today. A lab on a chip and the microfluidic chip are different names proposed by people in this field. With application of this subject extended from the analytical chemistry originally to a plurality of fields of research and application, and deep understanding of a researcher on this subject, the microfluidic chip has become a recognized term of this field.

A biochip refers to one kind of chip technology and can allow a series of known recognition molecules to be arranged in microarray on a surface of a substrate and combined with or react with a tested substance, then display and analyze by a certain method, and finally obtain information such as a chemical molecular structure, etc. of the tested substance. The biochip is widely applied, such as fields of molecular biology, biomedicine, drug research and development, etc. Compared with a traditional detection method, characteristics of being high-throughput, high in information quantity, fast, miniature, automated, widely applicable, etc. are realized.

### SUMMARY

An embodiment of the disclosure provides a modification method for a detection chip, including:

performing surface activation treatment on a hydrophilic layer on a first substrate of the detection chip to form a hydroxyl-containing modification group on a surface of the hydrophilic layer, wherein the hydrophilic layer covers sample application platforms disposed on the first substrate;

performing, with a solution containing an amino compound, surface amination treatment on the hydrophilic layer with the hydroxyl-containing modification group formed on the surface of the hydrophilic layer to form an amino-containing modification group on the surface of the hydrophilic layer; and

performing, with a solution containing an anhydride compound, surface carboxylation treatment on the hydrophilic layer with the amino-containing modification group formed on the surface of the hydrophilic layer to form a carboxyl-containing modification group on the surface of the hydrophilic layer.

In some embodiments, in the above modification method according to embodiments of the disclosure, the performing, with the solution containing the amino compound, the surface amination treatment on the hydrophilic layer with the hydroxyl-containing modification group formed on the surface of the hydrophilic layer, includes:

putting the first substrate having the hydrophilic layer with the hydroxyl-containing modification group formed on the surface of the hydrophilic layer into an ethanol solution or a toluene solution of 1%-2% (v/v) 3-aminopropyl triethoxysilane to be airtightly soaked for 12 h to 24 h in a normal temperature.

In some embodiments, in the above modification method according to embodiments of the disclosure, the performing, with the solution containing the anhydride compound, the surface carboxylation treatment on the hydrophilic layer with the amino-containing modification group formed on the surface of the hydrophilic layer, includes:

putting the first substrate having the hydrophilic layer with the amino-containing modification group formed on the surface of the hydrophilic layer into an N,N-dimethylformamide saturated solution of butanedioic anhydride to be soaked for 24 h to 48 h under conditions of the normal temperature and a normal pressure.

In some embodiments, in the above modification method according to embodiments of the disclosure, the performing, with the solution containing the anhydride compound, the surface carboxylation treatment on the hydrophilic layer with the amino-containing modification group formed on the surface of the hydrophilic layer, includes:

putting the first substrate having the hydrophilic layer with the amino-containing modification group formed on the surface of the hydrophilic layer into an N,N-dimethylformamide saturated solution of butanedioic anhydride to be subjected to circulation water bath for 24 h to 48 h between 75° C.−90° C.

In some embodiments, in the above modification method according to embodiments of the disclosure, the performing the surface activation treatment on the hydrophilic layer on the first substrate of the detection chip, includes:

putting the first substrate having the hydrophilic layer into a piranha solution to be soaked for 12 h to 24 h between 70° C.−90° C., wherein the piranha solution is composed of a concentrated sulphuric acid and 30% hydrogen peroxide, and a volume ratio of the concentrated sulphuric acid to the 30% hydrogen peroxide is 1:3.

In some embodiments, in the above modification method according to embodiments of the disclosure, after each of the surface activation treatment, the surface amination treatment and the surface carboxylation treatment, a following treatment is performed on the first substrate:

flushing the first substrate at least twice with deionized water; and

performing ultrasonic cleaning treatment on the flushed first substrate in the deionized water; and

drying the cleaned first substrate with nitrogen for standby application.

In some embodiments, in above modification method according to embodiments of the disclosure, before the performing the surface activation treatment on the hydrophilic layer on the first substrate of the detection chip, the method further includes:

performing ultrasonic cleaning on the first substrate having the hydrophilic layer by sequentially using acetone, ethanol and the deionized water as a solution, and drying the ultrasonic-cleaned first substrate with nitrogen for standby application.

In some embodiments, in the modification method according to embodiments of the disclosure, before the performing the ultrasonic cleaning on the first substrate having the hydrophilic layer by using the acetone as the solution, the method further includes:

forming a plurality of sample application platforms on the first substrate; and

forming the hydrophilic layer on the plurality of sample application platforms respectively.

In some embodiments, in the modification method according to embodiments of the disclosure, the forming the hydrophilic layer on the plurality of sample application platforms respectively, includes:

depositing a silicon oxide layer with a thickness of 300 nm on a layer of the sample application platforms at 390° C. by using a plasma enhanced chemical vapor deposition method;

and obtaining the hydrophilic layer by etching the silicon oxide layer and retaining the silicon oxide layer covering a region where each of the sample application platforms is located.

In another aspect, an embodiment of the disclosure further provides a detection chip, including:

a first substrate;

sample application platforms, on the first substrate; and

a hydrophilic layer, on the first substrate and covering the sample application platforms, wherein a surface of the hydrophilic layer has a carboxyl-containing modification group, and

the carboxyl-containing modification group is obtained by using the modification method according to above embodiments of the disclosure.

In some embodiments, the above detection chip according to embodiments of the disclosure, further includes:

a diversion dam, on the first substrate, extending along a first path and located between adjacent sample application platforms, wherein

the hydrophilic layer covers the diversion dam; and

a portion, covering the diversion dam, of the hydrophilic layer is independent of a portion, covering the sample application platforms, of the hydrophilic layer.

In some embodiments, in the above detection chip according to embodiments of the disclosure, a height of the diversion dam in a direction perpendicular to the first substrate is greater than a height of the sample application platforms in the direction perpendicular to the first substrate.

In some embodiments, the above detection chip according to embodiments of the disclosure, further includes:

a hydrophobic layer, on the first substrate;

wherein the sample application platforms and the diversion dam are all disposed on the hydrophobic layer.

In some embodiments, the above detection chip according to embodiments of the disclosure, further includes:

a second substrate, wherein the second substrate is arranged in opposite to the first substrate and spaced from the first substrate so as to provide a detection space.

In some embodiments, in the detection chip according to embodiments of the disclosure, at least one of the first substrate or the second substrate is a glass substrate.

In some embodiments, the above detection chip according to embodiments of the disclosure, further includes:

a sealant, located between the first substrate and the second substrate and surrounding the diversion dam and the plurality of sample application platforms.

### BRIEF DESCRIPTION OF THE DRAWINGS

FIG. 1 illustrates a flowchart of a modification method for a detection chip according to embodiments of the disclosure.

FIG. 2A illustrates a plane structure graph of a detection chip according to embodiments of the disclosure.

FIG. 2B illustrates a sectional view of a detection chip according to embodiments of the disclosure.

FIG. 3 illustrates a fluorography of antibody labeling by using a detection chip according to embodiments of the disclosure.

### DETAILED DESCRIPTION

In order to make objectives, technical solutions and advantages of embodiments of the disclosure clearer, the technical solutions of the embodiments of the disclosure will be described clearly and completely below with reference to accompanying drawings of the embodiments of the disclosure. Apparently, the described embodiments are some, but not all, of the embodiments of the disclosure. Based on the described embodiments of the disclosure, all of the other embodiments obtained by those of ordinary skill in the art without creative work fall within the protection scope of the disclosure.

It needs to be noted that unless otherwise specified, materials, reagents and the like used in the following embodiments can be obtained commercially. Sizes and shapes in each figure in the drawings do not reflect a true scale and only intend to illustrate the contents of the disclosure. The same or similar reference numbers represent the same or similar elements or elements with the same or similar functions all the time.

In the related art, a compound thin film with a carboxyl or containing other groups capable of being coupled with a protein is deposited or spin-coated on a glass substrate to realize fabrication of a detection chip for subsequent protein coupling. However, the glass substrate fabricated through a melting process has many defects, which leads to poor adhesion of the compound thin film to the glass substrate, tendency to falling off and influence on protein coupling efficiency.

At least for the above problem in the related art, embodiments of the disclosure provide a detection chip and a modification method therefor.

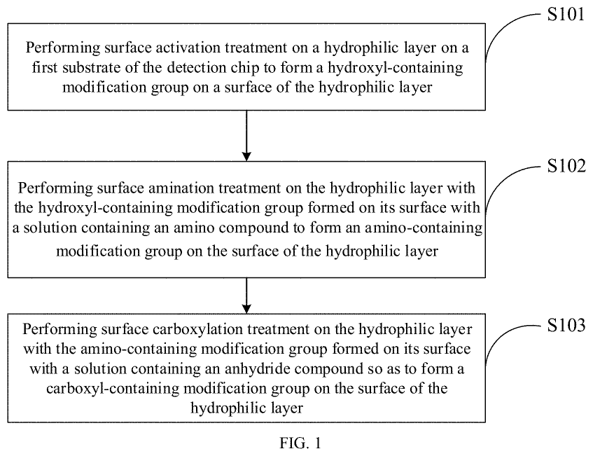

In some embodiments, a modification method for a detection chip according to embodiments of the disclosure, as shown in FIG. 1, includes the following steps.

S101, performing surface activation treatment on a hydrophilic layer on a first substrate of the detection chip to form a hydroxyl-containing modification group on a surface of the hydrophilic layer. The hydrophilic layer covers a sample application platform on the first substrate.

In some embodiments, the hydrophilic layer is generally made of a silicon oxide (SiOₓ) material. The surface activation treatment is performed on the silicon oxide material so that silicon oxide on the surface of the hydrophilic layer can be converted into a silicon hydroxyl, namely the hydroxyl-containing modification group is formed on the surface of the hydrophilic layer, as shown in a reaction formula I.

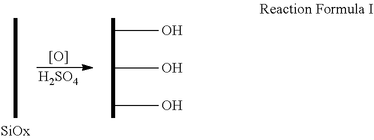

S102, performing surface amination treatment on the hydrophilic layer with the hydroxyl-containing modification group formed on its surface with a solution containing an amino compound to form an amino-containing modification group on the surface of the hydrophilic layer.

In some embodiments, the first substrate may be put in an organic solution of 3-aminopropyl triethoxysilane so as to form the amino-containing modification group on the surface of the hydrophilic layer, as shown in a reaction formula II.

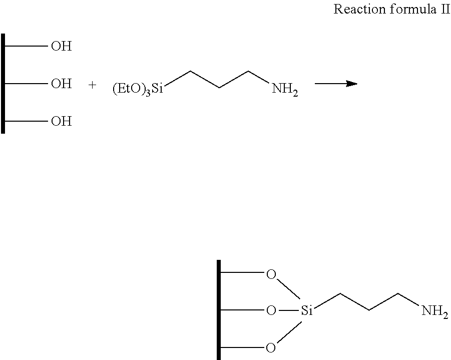

S103, performing surface carboxylation treatment on the hydrophilic layer with the amino-containing modification group formed on its surface with a solution containing an anhydride compound so as to form a carboxyl-containing modification group on the surface of the hydrophilic layer.

In some embodiments, the first substrate may be put in a saturated solution of butanedioic anhydride so as to form the carboxyl-containing modification group on the surface of the hydrophilic layer, as shown in a reaction formula III.

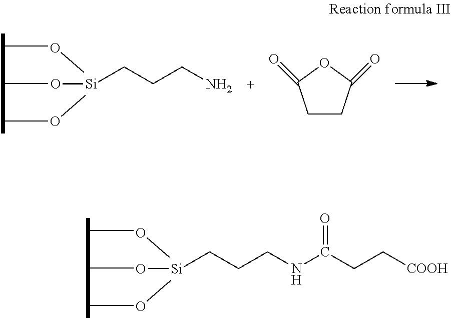

In the above modification method according to embodiments of the disclosure, a series of surface chemical reaction operations are performed on the surface of the hydrophilic layer of the detection chip so that a carboxyl connected through a chemical bond is generated on the surface of the hydrophilic layer, the problem that the compound thin film including the carboxyl on the detection chip is prone to falling off in the related art is solved, and the subsequent protein coupling efficiency is improved. It is suitable for a microfluidic system in vitro diagnosis, medicinal screening, cell culture, immunofluorescence assay, etc.

In some embodiments, in the above modification method according to embodiments of the disclosure, in S102, the surface amination treatment is performed on the hydrophilic layer with the hydroxyl-containing modification group formed on its surface with the solution containing the amino compound in the following mode:

the first substrate having the hydrophilic layer with the hydroxyl-containing modification group formed on its surface is vertically put in an amination jig according to a jig structure, and an ethanol solution or toluene solution of 1%-2% (v/v) 3-aminopropyl triethoxysilane (APTES) is injected into the amination jig for airtightly soaking for 12 h to 24 h in a normal temperature.

In some embodiments, a volume ratio (v/v) of the 3-aminopropyl triethoxysilane (APTES) in ethanol or toluene solution may be 1%, 1.2%, 1.5%, 1.8%, 2%, etc. The ethanol solution may be ultradry ethanol or 95% ethanol solution, the toluene solution may be ultradry toluene solution, and soaking time may be 12 h, 15 h, 16 h, 18 h, 20 h, 21 h, 24 h, etc.

In some embodiments, after S102, reaction liquid needs to be discarded, the first substrate is flushed at least twice with deionized water and is then subjected to ultrasonic cleaning for 5 min with the deionized water and to drying with nitrogen for standby application so that APTES or other impurities which are not reacted on the surface of the first substrate can be removed.

In some embodiments, in the above modification method according to embodiments of the disclosure, in S103, the surface carboxylation treatment is performed on the hydrophilic layer with the amino-containing modification group formed on its surface with the solution containing the anhydride compound in the following two options.

One of the options is: the first substrate having the hydrophilic layer with the amino-containing modification group formed on its surface is vertically put in a carboxylation jig according to a jig structure, an N,N-dimethylformamide (DMF) saturated solution of the butanedioic anhydride is added into the carboxylation jig for soaking for 24 h to 48 h under conditions of the normal temperature and a normal pressure.

In some embodiments, soaking time may be 24 h, 30 h, 35 h, 40 h, 45 h, 48 h, etc.

The other option is: the first substrate having the hydrophilic layer with the amino-containing modification group formed on its surface is vertically put in the carboxylation jig according to the jig structure, and an N,N-dimethylformamide saturated solution of the butanedioic anhydride is added into the carboxylation jig for circulating water bath for 24 h to 48 h between 75° C.-90° C.

In some embodiments, soaking time may be 24 h, 30 h, 35 h, 40 h, 45 h, 48 h, etc. A circulation temperature may be 75° C., 78° C., 80° C., 82° C., 85° C., 87° C., 90° C., etc. Circulation time may be 24 h, 27 h, 30 h, 35 h, 40 h, 45 h, 48 h, etc.

In some embodiments, after S103, reaction liquid needs to be discarded, the first substrate is flushed at least twice with the deionized water and is then subjected to ultrasonic cleaning for 10 min with the deionized water so as to remove impurities stuck to the first substrate in a carboxylation process. Then the ultrasonic-cleaned first substrate is dried with nitrogen and is then stored in a nitrogen atmosphere to complete modification for subsequent protein coupling.

In some embodiments, in the above modification method according to embodiments of the disclosure, in S101, the surface activation treatment is performed on the hydrophilic layer on the first substrate constituting the detection chip in the following mode:

the first substrate having the hydrophilic layer is vertically put in an activation jig according to a jig structure, and a piranha solution (concentrated sulphuric acid:30% hydrogen peroxide=1:3) is prepared on site and is slowly poured into the activation jig without being cooled for stirring water bath for 12 h to 24 h between 70° C.-90° C.

In some embodiments, a stirring water bath temperature may be 70° C., 72° C., 75° C., 80° C., 83° C., 85° C., 88° C., 90° C., etc. Stirring water bath time may be 12 h, 15 h, 18 h, 20 h, 21 h, 24 h, etc.

In some embodiments, after S101, the piranha solution needs to be discarded and properly handled, the first substrate is flushed at least twice with the deionized water and is then subjected to ultrasonic cleaning for 10 min with the deionized water so as to remove impurities on the surface of the first substrate in an activation process, and finally the first substrate is dried with nitrogen for standby application.

In some embodiments, in the above modification method according to embodiments of the disclosure, before the surface activation treatment is performed on the hydrophilic layer on the first substrate of the detection chip in S101, the following steps may be further executed:

performing ultrasonic cleaning on the first substrate having the hydrophilic layer by sequentially using acetone, the ethanol and the deionized water as a solution, and the finally the ultrasonic-cleaned first substrate is dried with the nitrogen for standby application.

In some embodiments, after a film layer such as the hydrophilic layer is fabricated on a master glass substrate, the master glass substrate with a thickness of 0.5 mm is cut into a size of a glass slide based on a standard of 1 in×3 in and is then put in a cleaning jig as the first substrate to be pre-cleaned. A cleaning process sequentially includes: ultrasonic cleaning for 10 min with the acetone, ultrasonic cleaning for 10 min with the ethanol, ultrasonic cleaning for 10 min with the deionized water, and then ultrasonic cleaning for 10 min again with the deionized water. In this way, other impurities such as grease on the surface of the first substrate can be cleaned away. The first substrate is dried with the nitrogen for standby application after cleaning is completed.

In some embodiments, in the above modification method according to embodiments of the disclosure, before ultrasonic cleaning is performed on the first substrate having the hydrophilic layer by using the acetone as the solution, the following steps may be further executed:

a plurality of sample application platforms are formed on the first substrate; and

the hydrophilic layer is formed on each of the sample application platforms respectively.

In the related art, the first substrate of the detection chip has hydrophobicity to a certain degree, a solvent contained in a to-be-detected solution in a biological field is usually water, so contact between the to-be-detected solution and the first substrate is poor, and it is disadvantageous to binding a marker in the to-be-detected solution to the detection chip. Silicon oxide has hydrophilicity so that the detection chip provided by the disclosure can make better close contact with the to-be-detected solution, and thus a detection effect can be improved.

In some embodiments, in the above modification method according to embodiments of the disclosure, the hydrophilic layer is formed on each of the sample application platforms respectively in the following mode:

a silicon oxide layer with a thickness of 300 nm is deposited on a layer where the sample application platforms are located at 390° C. by using a plasma enhanced chemical vapor deposition (PECVD) method; and

the silicon oxide layer is etched and the silicon oxide layer covering a region where each of the sample application platforms is located is retained so as to obtain the hydrophilic layer.

The hydrophilic layer of the silicon oxide material formed by the above method has advantages of being good in film thickness uniformity, having few film layer pinholes, being not prone to cracking, etc. so that a contact effect of the to-be-detected solution and the detection chip is better.

It is worth noticing that parameters of time, temperature and the like appearing in the above modification process are only exemplary rather than serve as limitations.

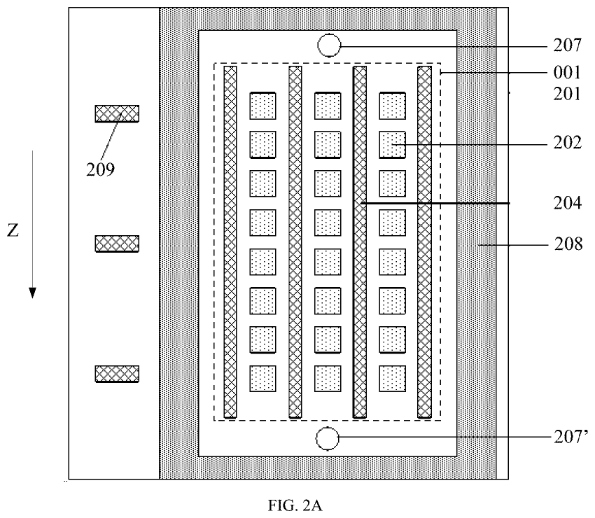

Based on the same inventive concept, an embodiment of the disclosure further provides a detection chip, as shown in FIG. 2A and FIG. 2B, including: a first substrate 201, sample application platforms 202 on the first substrate 201 and a hydrophilic layer 203 covering the sample application platforms 202. A surface of the hydrophilic layer 203 has an amino-containing modification group 203′. The amino-containing modification group is obtained by using the above modification method according to embodiments of the disclosure.

FIG. 2A is a schematic plane graph of a detection chip provided by some embodiments of the disclosure. FIG. 2B is a schematic sectional view of the detection chip as shown in FIG. 2A.

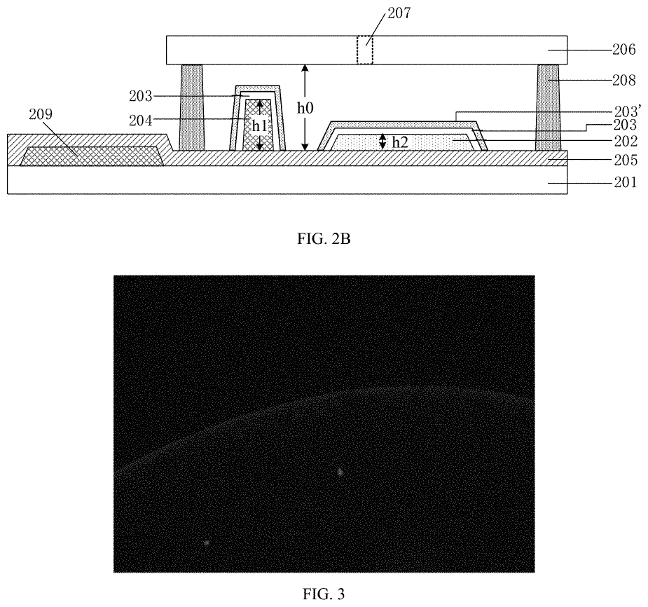

In some embodiments, the modification group 203′ on the surface of the hydrophilic layer 203 is obtained by using the above modification method according to embodiments of the disclosure. The modification group 203′ has a carboxyl which can be bound to a target antigen or antibody. In some embodiments, as shown in FIG. 3, a region in light color (namely a lower half portion in the figure) reveals a test result of a connection efficiency between a fluorescently-labeled antibody and the carboxyl in the modification group 203′. The result shows that a high carboxyl grafting density of the surface of the detection chip provided by the disclosure leads to ultra-high protein coupling efficiency and ultra-low nonspecific adsorption during its binding to a protein such as the antibody.

In some embodiments, the first substrate 201 plays a role of supporting, protection and the like and may be a plastic substrate, a glass substrate or a silicon substrate or other suitable substrates, which is not limited by the embodiment of the disclosure. For example, when a glass substrate is adopted, the cost is low, and when the silicon substrate is adopted, its properties are better. For example, the first substrate 201 is a transparent substrate (for example, the glass substrate) so that light can penetrate through the transparent substrate without loss or with low loss, thus accuracy of subsequent optical detection can be improved, and a requirement for an extra provided optical detection device is lowered.

In some embodiments, the plurality of sample application platforms 202 are disposed on the first substrate 201. For example, the sample application platforms 202 are used for providing an adhesion position for the target antigen or antibody. For example, in some examples, the sample application platforms 202 are in a boss shape so that the target antigen or antibody adhering to the sample application platforms can be conveniently bound to or react with a marker in the to-be-detected solution flowing through the sample application platforms 202. Certainly, the embodiment of the disclosure is not limited to this, the sample application platforms 202 may also be in a groove shape or a plane shape as long as it can be guaranteed that the target antigen or antibody adhering to the sample application platforms 202 can make contact with the to-be-detected solution flowing through the sample application platforms 202 and be bound to the marker in the to-be-detected solution. It needs to be noted that in the embodiment of the disclosure, the quantity of the sample application platforms 202 is not limited and may be any number, which, for example, may be determined according to a type and a concentration of the marker needing to be detected.

In some embodiments, the above detection chip according to embodiments of the disclosure, as shown in FIG. 2A and FIG. 2B, may further include: diversion dams 204 on the first substrate 201, extending along a first path and located between the adjacent sample application platforms 202. The hydrophilic layer 203 covers the diversion dams 204, and a portion, covering the diversion dams 204, of the hydrophilic layer 203 is independent from a portion, covering the sample application platforms 202, of the hydrophilic layer 203.

In some embodiments, diversion dams 204 are disposed on the first substrate 201, extend along the first path and are located among the adjacent sample application platforms 202. The diversion dams 204 have an influence on a flow field of an inner space of the detection chip so that flowing speed uniformity of positions where the different sample application platforms 202 are located can be improved, parallelism of the flow field along the first path can be improved, stability of the flow field can be improved, and thus the to-be-detected solution can steadily and uniformly flow through the regions where the sample application platforms 202 are located. Therefore, the marker in the to-be-detected solution can be fully bound to or fully react with the target antigen or antibody on the sample application platforms 202 so that it is helpful for improving accuracy and reliability of an immunodetection result. Besides, the detection chip further has characteristics of small size, high throughput, etc.

For example, in some examples, as shown in FIG. 2A, the plurality of sample application platforms 202 are arranged in a plurality of columns, and the first path extends in a column direction Z. The diversion dams 204 are arranged on two sides of each column of the sample application platforms 202, and the plurality of diversion dams 204 are parallel to each other. When the to-be-detected solution flows through the plurality of sample application platforms 202 in the column direction Z, the parallelism, in the column direction Z, of the flow field formed by flowing of the to-be-detected solution is improved under the action of the diversion dams 204, and thus the to-be-detected solution can steadily and uniformly flow in the column direction Z.

It needs to be noted that in the embodiment of the disclosure, the first path is not limited to extending in the column direction Z and may extend in any other direction. Besides, the first path can extend linearly or along a curve, which can be determined according to a flowing path and flowing mode of the to-be-detected solution and is not limited by the embodiment of the disclosure. For example, when the first path extends linearly, the diversion dams 204 may also extend linearly, and when the first path extends along the curve, the diversion dams 204 may also extend along the curve. Correspondingly, the plurality of sample application platforms 202 may be arranged linearly in a plurality of columns or arranged in a plurality of groups along a curve. The diversion dams 204 located among the adjacent sample application platforms 202 extend in an arrangement direction of the sample application platforms 202.

It needs to be noted that in the embodiment of the disclosure, the diversion dams 204 may be arranged on the two sides of each column of the sample application platforms 202, or the diversion dams 204 may be arranged on two sides of only some columns of sample application platforms 202. The diversion dams 204 may be arranged according to needed parallelism of the flow field, which is not limited by the embodiment of the disclosure.

For example, when the diversion dams 204 are arranged on the two sides of each column of the sample application platforms 202 (for example, the sample application platforms 202 and the diversion dams 204 are arranged in a mode as shown in FIG. 2A), the flow field has better parallelism. If the target antigen or antibody on a certain sample application platform 202 accidentally falls off, the falling-off target antigen or antibody will flow in the column direction Z, namely, flowing in a region where this column of sample application platforms 202 is located, thereby not affecting the other columns of sample application platforms 202, avoiding crosstalk between different detection sites (namely the sample application platforms 202) and avoiding cross contamination.

For example, the quantity of the diversion dams 204 is not limited and may be one or more. For example, in some examples, if the plurality of sample application platforms 202 are only arranged in two columns, only one diversion dam 204 may be arranged and located between the two columns of sample application platforms 202, thereby reducing the quantity of the diversion dams 204 and meanwhile making the parallelism of the flow field better.

For example, a cross-section shape of the diversion dam 204 in a direction perpendicular to the first path (for example, the column direction Z) may be rectangular, square, trapezoidal, semi-circular or other suitable shapes, for example, it may be a regular shape or an irregular shape, which is not limited by the embodiment of the disclosure. For example, different cross-section shapes may have different degrees of influences on the flow field, so the cross-section shape of the diversion dam 204 may be determined according to characteristics of the flow field.

For example, the diversion dam 204 and the sample application platforms 202 may be all prepared by using photoresist. The photoresist may be, for example, photoresist capable of thick film etching. For example, in some examples, the diversion dam 204 and the sample application platforms 202 may be formed in the same patterning process so as to simplify a production process.

In some embodiments, the above detection chip according to embodiments of the disclosure, as shown in FIG. 2B, may further include: a hydrophobic layer 205 disposed on the first substrate 201. The sample application platforms 202 and the diversion dams 204 are all located on the hydrophobic layer 205. By arranging the hydrophobic layer 205, the to-be-detected solution can flow more easily in the detection chip, the marker in the to-be-detected solution is not prone to adhering to the first substrate 201 so as to avoid waste of the marker in the to-be-detected solution.

For example, a material of the hydrophobic layer 205 is a resin or a silicon nitride. Certainly, the hydrophobic layer 205 may also be made of other proper inorganic or organic materials as long as it is guaranteed that one side of the hydrophobic layer 205 facing away from the first substrate 201 has hydrophobicity. For example, the hydrophobic layer 205 may be directly prepared from a hydrophobic material. For another example, the hydrophobic layer 205 may be prepared from a non-hydrophobic material. In this case, it is needed to perform hydrophobization treatment on a surface of the hydrophobic layer 205 facing away from the first substrate 201 so that the surface of the hydrophobic layer 205 facing away from the first substrate 201 has hydrophobicity.

In some embodiments, the above detection chip according to embodiments of the disclosure, as shown in FIG. 2B, may further include: a second substrate 206 in opposite to the first substrate 201 and spaced from the first substrate 201 so as to provide a detection space (namely a liquid flowing space). A material of the second substrate 206 may be the same as or different from the material of the first substrate 201, which is not limited by the embodiment of the disclosure. For example, the second substrate 206 is a transparent substrate (for example, a glass substrate) so that light can penetrate through the transparent substrate without loss or with low loss, thus accuracy of subsequent optical detection can be improved, and a requirement for an extra provided optical detection device is lowered.

In some embodiments, the above detection chip according to embodiments of the disclosure, as shown in FIG. 2A, may further include a sample inlet 207, a sample outlet 207′ and a detection region 001. For example, the plurality of sample application platforms 202 are located in the detection region 001 and arranged in the plurality of columns, and the sample inlet 207 and the sample outlet 207′ are distributed at two sides (for example, located on an upper side and a lower side in the figure) of the detection region 001 in the column direction Z. For example, the to-be-detected solution may be injected into the sample inlet 207 through a micro-injection pump or a pipette, flow through the plurality of sample application platforms 202 in the column direction Z and then flow out from the sample outlet 207′. For example, the sample inlet 207 and the sample outlet 207′ are distributed at the two sides of the detection region 001 in an axial symmetry or central symmetry in the column direction Z so that the parallelism and stability of the flow field can be further improved. Certainly, the embodiment of the disclosure is not limited to this, and the sample inlet 207 and the sample outlet 207′ may also be distributed in dissymmetry, which may be determined according to the characteristics of the flow field and actual demands.

In some embodiments, the sample inlet 207 and the sample outlet 207′ are disposed on the second substrate 206. For example, as shown in FIG. 2B, the sample inlet 207 may be a through hole running through the second substrate 206. A cross-section shape of the through hole parallel to the second substrate 206 may be circular, rectangular, square or any suitable shapes. Similarly, the sample outlet 207′ may also be a through hole running through the second substrate 206, and a cross-section shape of the sample outlet 207′ parallel to the second substrate 206 may be the same as or different from that of the sample inlet 207. It needs to be noted that FIG. 2B only exemplarily shows an arrangement mode of the sample inlet 207 on the second substrate 206, and a relative position of the sample inlet 207 and the sample application platforms 202 is not limited by the mode shown in FIG. 2B.

In some embodiments, the above detection chip according to embodiments of the disclosure, as shown in FIG. 2B, may further include: sealant 208 between the first substrate 201 and the second substrate 206. The sealant 208 serves as a supporting component surrounding the diversion dam 204 and the plurality of sample application platforms 202. In some embodiments, a flowing space of the to-be-detected solution is defined jointly by the first substrate 201, the second substrate 206 and the sealant 208. For example, in some examples, a pad may be mixed in the sealant 208 so that a space between the first substrate 201 and the second substrate 206 can be controlled through the pad, and compressive strength of the detection chip is enhanced.

In some embodiments, in the above detection chip according to embodiments of the disclosure, as shown in FIG. 2B, a height h1 of the diversion dam 204 in a direction perpendicular to the first substrate 201 is greater than a height h2 of the sample application platforms 202 in a direction perpendicular to the first substrate 201 so that an effect of adjusting the parallelism of the flow field can be better realized. In some embodiments, the height h1 of the diversion dam 204 is 30% to 60% (for example, 40% or 50%) of a distance h0 between the first substrate 201 and the second substrate 206. For example, in some examples, the distance h0 between the first substrate 201 and the second substrate 206 is 100 micrometers, the height h1 of the diversion dam 204 is 50 micrometers, the height h2 of the sample application platforms 202 is 3 micrometers, the height h1 differs greatly from the height h2, and thus the parallelism of the flow field can be better adjusted. For example, in some examples, when the cross-section shape of the diversion dam 204 in the direction (for example, the column direction Z) perpendicular to the first path is semi-circular. A radius of the semi-circular shape may be greater than or equal to half of the distance h0 between the first substrate 201 and the second substrate 206.

It needs to be noted that in the embodiment of the disclosure, the height h1 may refer to its own height of the diversion dam 204 or refer to a sum of the height of the diversion dam 204 and a height of the hydrophilic layer 203. Likewise, the height h2 may refer to its own height of each of the sample application platforms 202 or refer to a sum of the height of the each of the sample application platforms 202 and the height of the hydrophilic layer 203.

In some embodiments, when the above detection chip according to embodiments of the disclosure is used, the target antigen or antibody adheres to the sample application platforms 202 firstly before the first substrate 201 and the second substrate 206 are aligned. For example, liquid containing the target antigen or antibody may be dropped on the sample application platforms 202 dropwise, as there is the modification group 203′, the target antigen or antibody is bound to the modification group 203′, thereby adhering to the sample application platforms 202. Then, the first substrate 201 and the second substrate 206 are aligned with the sealant 208. The to-be-detected solution is injected into the sample inlet 207, flows through the detection region 001 and then flows out from the sample outlet 207′. The marker in the to-be-detected solution may be bound to or react with the target antigen or antibody adhering to the sample application platforms 202 when flowing through the sample application platforms 202. Then, for example, a bovine serum albumin (BSA) solution may be injected into the detection chip so as to clean the inner space of the detection chip to reduce adsorption of other portions, besides the sample application platforms 202, in the inner space of the detection chip for the to-be-detected solution and thus improve the accuracy of the subsequent detection. Finally, optical detection is performed on the detection chip by using the optical detection device so as to obtain the immunodetection result.

In some embodiments, the above detection chip according to embodiments of the disclosure, as shown in FIG. 2A and FIG. 2B, may further include a positioning component 209. The positioning component 209 is configured to cooperate with the optical detection device to realize positioning of the detection chip, so that the optical detection device conveniently performs optical detection on the detection chip. For example, the positioning component 209 is arranged on the first substrate 201 and covered with the hydrophobic layer 205. The positioning component 209 may be made of a metal material, for example, molybdenum (Mo) or made of an opaque insulating material, which is not limited by the embodiment of the disclosure.

For example, in some examples, during positioning, an optical positioning apparatus of the optical detection device emits light for positioning. If the detection chip is located in a preset position, as the positioning component 209 is opaque, light intensity detected by a sensor arranged in a corresponding position is pretty low or zero, and thus it can be judged that the detection chip is located in the preset position to realize positioning. After positioning is completed, optical detection and signal reading can be performed on a specific site by using the optical detection device. For example, the specific site is one or some of the sample application platforms 202 with the target antigen or antibody adhering thereto.

In some embodiments, the positioning component 209 is located outside the detection region 001, for example further located outside the liquid flowing space formed by the first substrate 201, the second substrate 206 and the sealant 208 so as to avoid affecting the optical detection. For example, in some examples, as shown in FIG. 2A, a plurality of positioning components 209 are arranged on one side of the detection chip and are close to an edge of the detection chip. By arranging the plurality of positioning components 209, positioning accuracy can be improved. Certainly, the embodiment of the disclosure is not limited to this, an arrangement position of the positioning component 209 may be determined according to actual demands, for example, may be arranged any side, any two sides, around or other suitable positions of the detection chip, which can be determined according to a positioning mode of the optical detection device matched with it. The quantity of the positioning components 209 is also not limited and may be any number, which may be determined according to actual demands.

To sum up, in the detection chip and the modification method therefor according to embodiments of the disclosure, the activation treatment is performed on the hydrophilic layer of the detection chip so that the hydroxyl-containing modification group can be formed on the surface of the hydrophilic layer; then the surface amination treatment is performed on the hydrophilic layer with the solution containing the amino compound so that the amino-containing modification group can be formed on the surface of the hydrophilic layer; and finally, the surface carboxylation treatment is performed on the hydrophilic layer with the solution containing the anhydride compound so that the high-density carboxyl-containing modification group can be formed on the surface of the hydrophilic layer. That is, through the above series of surface chemical reactions, the carboxyl connected in the chemical bond is generated on the surface of the hydrophilic layer, so that the problem that in the related art, the compound thin film including the carboxyl on the detection chip is prone to falling off is solved, and the subsequent protein coupling efficiency is improved. It is suitable for a microfluidic system needed by in vitro diagnosis, medicinal screening, cell culture, immunofluorescence assay, etc. Besides, the above modification method provided by the disclosure is performed on the basis of the glass substrate, thereby facilitating mass production and also effectively reducing cost. Besides, it can be seen from the above description that an operation process of the above modification method provided by the disclosure is relatively simple, thereby helping to improve the efficiency.

It needs to be noted that the disclosure describes the technical method of the disclosure through the above embodiments but is not limited to the above technical steps, that is, it does not mean that the disclosure can be implemented only depending on the above technical steps. Those of skill in the art should understand that any improvement to the disclosure, equivalent replacements of selected raw materials of the disclosure, adding of helper constituents, selection of specific modes, etc. all fall within the protection scope and disclosed scope of the disclosure.

1. A modification method for a detection chip, comprising:
performing surface activation treatment on a hydrophilic layer on a first substrate of the detection chip to form a hydroxyl-containing modification group on a surface of the hydrophilic layer, wherein the hydrophilic layer covers sample application platforms disposed on the first substrate;
performing, with a solution containing an amino compound, surface amination treatment on the hydrophilic layer with the hydroxyl-containing modification group formed on the surface of the hydrophilic layer to form an amino-containing modification group on the surface of the hydrophilic layer; and
performing, with a solution containing an anhydride compound, surface carboxylation treatment on the hydrophilic layer with the amino-containing modification group formed on the surface of the hydrophilic layer to form a carboxyl-containing modification group on the surface of the hydrophilic layer.

2. The modification method according to claim 1, wherein the performing, with the solution containing the amino compound, the surface amination treatment on the hydrophilic layer with the hydroxyl-containing modification group formed on the surface of the hydrophilic layer, comprises:
putting the first substrate having the hydrophilic layer with the hydroxyl-containing modification group formed on the surface of the hydrophilic layer into an ethanol solution or a toluene solution of 1%-2% (v/v) 3-aminopropyl triethoxysilane to be airtightly soaked for 12 h to 24 h in a normal temperature.

3. The modification method according to claim 1, wherein the performing, with the solution containing the anhydride compound, the surface carboxylation treatment on the hydrophilic layer with the amino-containing modification group formed on the surface of the hydrophilic layer, comprises:
putting the first substrate having the hydrophilic layer with the amino-containing modification group formed on the surface of the hydrophilic layer into an N,N-dimethylformamide saturated solution of butanedioic anhydride to be soaked for 24 h to 48 h under conditions of the normal temperature and a normal pressure.

4. The modification method according to claim 1, wherein the performing, with the solution containing the anhydride compound, the surface carboxylation treatment on the hydrophilic layer with the amino-containing modification group formed on the surface of the hydrophilic layer comprises:
putting the first substrate having the hydrophilic layer with the amino-containing modification group formed on the surface of the hydrophilic layer into an N,N-dimethylformamide saturated solution of butanedioic anhydride to be subjected to circulation water bath for 24 h to 48 h between 75 [symbol] -90 [symbol] .

5. The modification method according to claim 1, wherein the performing the surface activation treatment on the hydrophilic layer on the first substrate of the detection chip, comprises:
putting the first substrate having the hydrophilic layer into a piranha solution to be soaked for 12 h to 24 h between 70 [symbol] -90 [symbol] , wherein the piranha solution is composed of a concentrated sulphuric acid and 30% hydrogen peroxide, and a volume ratio of the concentrated sulphuric acid to the 30% hydrogen peroxide is 1:3.

6. The modification method according to claim 1, wherein after each of the surface activation treatment, the surface amination treatment and the surface carboxylation treatment, a following treatment is performed on the first substrate:
flushing the first substrate at least twice with deionized water; and
performing ultrasonic cleaning treatment on the flushed first substrate in the deionized water; and
drying the cleaned first substrate with nitrogen for standby application.

7. The modification method according to claim 1, before the performing the surface activation treatment on the hydrophilic layer on the first substrate of the detection chip, further comprising:
performing ultrasonic cleaning on the first substrate having the hydrophilic layer by sequentially using acetone, ethanol and the deionized water as a solution, and drying the ultrasonic-cleaned first substrate with nitrogen for standby application.

8. The modification method according to claim 7, before the performing the ultrasonic cleaning on the first substrate having the hydrophilic layer by using the acetone as the solution, further comprising:
forming a plurality of sample application platforms on the first substrate; and
forming the hydrophilic layer on the plurality of sample application platforms respectively.

9. The modification method according to claim 8, wherein the forming the hydrophilic layer on the plurality of sample application platforms respectively, comprises:
depositing a silicon oxide layer with a thickness of 300 nm on a layer of the sample application platforms at 390 [symbol] by using a plasma enhanced chemical vapor deposition method; and
obtaining the hydrophilic layer by etching the silicon oxide layer and retaining the silicon oxide layer covering a region where each of the sample application platforms is located.

10. A detection chip, comprising:
a first substrate;
sample application platforms, on the first substrate; and
a hydrophilic layer, on the first substrate and covering the sample application platforms, wherein a surface of the hydrophilic layer has a carboxyl-containing modification group, and
the carboxyl-containing modification group is obtained by using the modification method according to claim 1.

11. The detection chip according to claim 10, further comprising:
a diversion dam, on the first substrate, extending along a first path and located between adjacent sample application platforms, wherein
the hydrophilic layer covers the diversion dam; and
a portion, covering the diversion dam, of the hydrophilic layer is independent of a portion, covering the sample application platforms, of the hydrophilic layer.

12. The detection chip according to claim 11, wherein a height of the diversion dam in a direction perpendicular to the first substrate is greater than a height of the sample application platforms in the direction perpendicular to the first substrate.

13. The detection chip according to claim 11, further comprising:
a hydrophobic layer, on the first substrate;
wherein the sample application platforms and the diversion dam are all disposed on the hydrophobic layer.

14. The detection chip according to claim 11, further comprising:
a second substrate, wherein the second substrate is arranged in opposite to the first substrate and spaced from the first substrate so as to provide a detection space.

15. The detection chip according to claim 14, wherein at least one of the first substrate or the second substrate is a glass substrate.

16. The detection chip according to claim 14, further comprising:
a sealant, located between the first substrate and the second substrate and surrounding the diversion dam and the plurality of sample application platforms.

17. The detection chip according to claim 14, further comprising:
a sample inlet;
a sample outlet; and
a detection region;
wherein the plurality of sample application platforms are located in the detection region and arranged in the plurality of columns; and
the sample inlet and the sample outlet are distributed at two sides of the detection region in a column direction.

18. The detection chip according to claim 14, further comprising:
a positioning component, configured to cooperate with an optical detection device to realize positioning of the detection chip.

19. The modification method according to claim 2, wherein after each of the surface activation treatment, the surface amination treatment and the surface carboxylation treatment, a following treatment is performed on the first substrate:
flushing the first substrate at least twice with deionized water; and
performing ultrasonic cleaning treatment on the flushed first substrate in the deionized water; and
drying the cleaned first substrate with nitrogen for standby application.

20. The modification method according to claim 3, wherein after each of the surface activation treatment, the surface amination treatment and the surface carboxylation treatment, a following treatment is performed on the first substrate:
flushing the first substrate at least twice with deionized water; and
performing ultrasonic cleaning treatment on the flushed first substrate in the deionized water; and
drying the cleaned first substrate with nitrogen for standby application.
